(19) United States
(12) Patent Application Publication
(10) Pub. No.: US 2019/0248472 A1
(43) Pub. Date: Aug. 15, 2019

(54) PROPELLER ASSEMBLY

(71) Applicant: GE AVIATION SYSTEMS LLC, GRAND RAPIDS, MI (US)

(72) Inventor: Gábor Zipszer, Cheltenham (GB)

(21) Appl. No.: 16/345,333

(22) PCT Filed: Sep. 27, 2017
(86) PCT No.: PCT/US2017/053576

§ 371 Date: Apr. 26, 2019

(30) Foreign Application Priority Data
Oct. 27, 2016 (GB) 1618154.7

(51) Int. Cl. B64C 11/18; B64C 11/10

(52) U.S. Cl. CPC B64C 11/18; B64C 11/26; B64C 11/10

(57) ABSTRACT

A propeller blade spanning radially from a root to a tip and spanning axially from a leading edge to a trailing edge spaced from the leading edge forming an airfoil therebetween where a sweep line can be defined as a spline fitted through points which are positioned along the chord line. The propeller blade having at least one spline defining the leading edge or trailing edge.

### CROSS-REFERENCE TO RELATED APPLICATIONS

This application is a National Phase application of International Application No. PCT/US2017/053576, filed Sep. 27, 2017, which claims the benefit of GB Application 1618154.7, filed on Oct. 27, 2016, both which are incorporated herein in in their entireties.

### TECHNICAL FIELD

The disclosure generally relates to a propeller assembly, and more particularly to a propeller blade for the propeller assembly.

### BACKGROUND

Contemporary turbo-prop engine aircraft can include one or more propellers attached to engines of the aircraft. Aircraft engines can be configured to receive and operate more than one propeller type. An engine controller system can be configured to operate the aircraft engine based on the propeller type installed, and can be adjusted to utilize the specific propeller characteristics of the selected propeller type.

### BRIEF DESCRIPTION

In one aspect, the present disclosure relates to a propeller blade, including a leading edge, a trailing edge spaced from the leading edge, and a set of airfoil sections between the leading edge and the trailing edge and extending radially between a blade root and a blade tip wherein a sweep line of the propeller blade comprises at least one inflection point.

Non-limiting permutations of aspects of the disclosure can also include:

A straight spar internal structure.

A sweep angle of the blade tip is greater than 50 degrees.

The blade tip comprises a variable sweep angle that ranges from 50 degrees to 90 degrees.

The blade tip has a length that is 10 percent of a total length of the propeller blade.

A spline along the leading edge comprises a backward swept section.

The backward swept section is located in an inner region between the blade root and a blade outer region.

The leading edge at the blade spinner coupling is rearwardly angled.

The leading edge is rearwardly angled between 30 degrees and 85 degrees.

The set of airfoil sections define an S-shaped planform.

The trailing edge is a waved trailing edge.

In another aspect, the present disclosure relates to a propeller assembly, including a rotatable hub, a set of propeller blades with a blade, including a leading edge a trailing edge spaced from the leading edge and forming an airfoil there between, a radially inner region located between a blade root and fifty percent of the total length of the propeller blade, a radially outer region located between the radially inner region and a blade tip of the propeller blade, wherein a sweep line of the blade at the inner region is one of concave or convex and a sweep line of the blade at the outer region is the other of concave or convex.

Non-limiting permutations of aspects of the disclosure can also include:

The leading edge of the blade at the rotatable hub is rearwardly angled.

The blade tip comprises a sweep angle greater than 50 degrees.

The blade tip comprises a variable sweep angle that ranges from 50 degrees to 90 degrees.

The blade further comprises a straight spar internal structure.

In yet another aspect, the present disclosure relates to a propeller, including a blade body having a leading edge and a trailing edge spaced from the leading edge and forming an airfoil there between with an S-shaped planform having at least one inflection point defined by a point where a sweep line of the blade body changes from being one of concave or convex to the other of concave or convex.

Non-limiting permutations of aspects of the disclosure can also include:

The blade body further comprises a straight spar internal structure.

The trailing edge is a waved trailing edge.

The leading edge at the blade spinner coupling is rearwardly angled.

To the extent not already described, the different features and structures of the various non-limiting permutations can be used in combination, or in substitution with each other as desired.

### BRIEF DESCRIPTION OF THE DRAWINGS

In the drawings:

FIG. 1 illustrates an example schematic top view of an aircraft having wings, engines, and propellers in accordance with various aspects described herein.

FIG. 2 is a perspective view of a propeller blade and portion of a hub that can be utilized in the aircraft of FIG. 1.

FIG. 3 is a cross-sectional view of an airfoil of the propeller blade of FIG. 2.

FIG. 4 is a planform view of the propeller of FIG. 2.

FIG. 5A is an enlarged view of a tip region of the propeller blade.

FIG. 5B is an enlarged view of a root region of the propeller blade.

### DETAILED DESCRIPTION

The various aspects described herein are related to a propeller blade having an S-shape profile when viewed in planform. Embodiments of the disclosure can be implemented in any environment, apparatus, or method for a propeller, regardless of the function performed by the propeller. By way of non-limiting example, such propellers can be utilized on aircraft, watercraft, wind turbines, and the like. The remainder of this applications focuses on an aircraft environment.

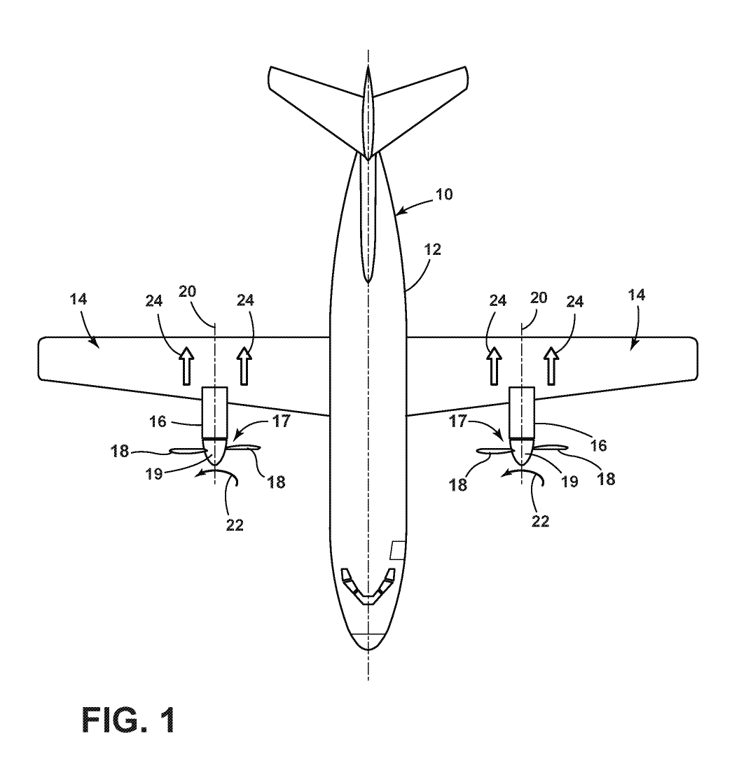

FIG. 1 depicts an aircraft 10 having a fuselage 12 and wings 14 extending outward from the fuselage 12. The aircraft 10 can include at least one turbo-prop aircraft engine 16 coupled to the aircraft 10, shown as a set of engines 16 coupled with the opposing wings 14. The engine 16 can include a set of propeller assemblies 17 coupled with the engine 16, and including propeller blades 18 and a rotatable hub assembly having a spinner 19.

The engine 16 drives a rotation 22 of the propeller assembly 17 about a propeller assembly axis of rotation 20. The propeller blades 18 can further be configured or angled relative to the propeller assembly axis of rotation 20 such that the rotation 22 of the propeller blades 18 generates thrust (illustrated as arrow 24) for the aircraft 10. While an aircraft 10 having two turbo-prop engines 16 has been illustrated, embodiments of the disclosure can include any number of engines 16, propeller assemblies 17, or propeller blades 18, or any placement of the engine 16, assemblies 17, or blades 18 relative to the aircraft. Embodiments of the disclosure can further be applied to different aircraft engine 16 types, including, but not limited to, piston-based combustion engines, or electrically-driven engines. Additionally, the rotation 22 of the propeller assemblies 17 or propeller blades 18 is provided for understanding of the embodiments of the disclosure. Embodiments of the disclosure can include alternative directions of rotation 22 of the propeller assemblies 17 or propeller blades 18, or embodiments wherein a set of engines 16 rotate propeller blades 18 in the same or opposing directions.

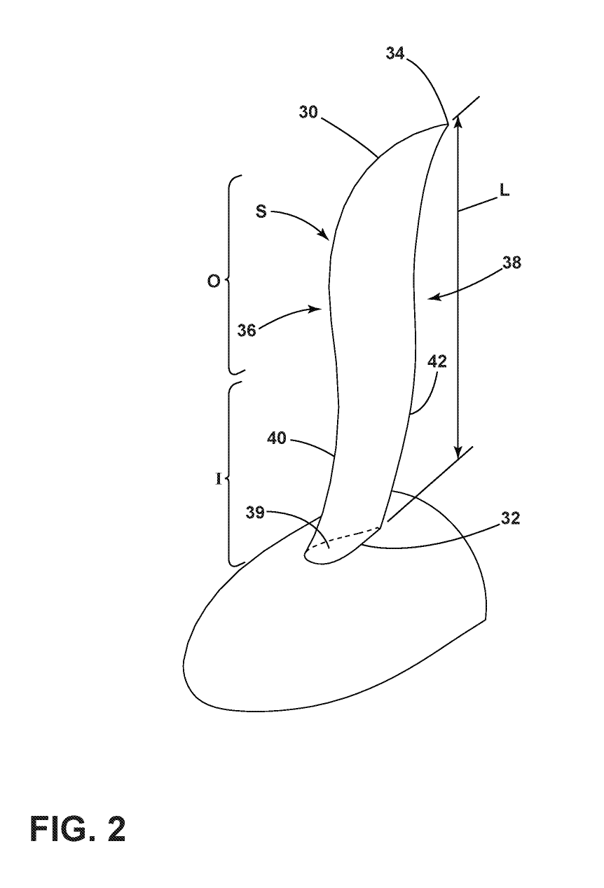

FIG. 2 is a perspective view of the propeller assembly 17 illustrating a portion of the propeller hub including the spinner 19 and a body 30 of a single propeller blade 18. As shown the propeller blade includes a total radial length L and extends radially outward from the spinner 19. A blade root 32 is included and includes where an airfoil 39 of the propeller blade 18 couples with the spinner 19. The body 30 radially extends from the blade root 32 to a blade tip 34. The body 30 axially spans from a leading edge 36 to a trailing edge 38, which is spaced from the leading edge 36. The airfoil 39 is formed between the leading edge 36 and the trailing edge 38.

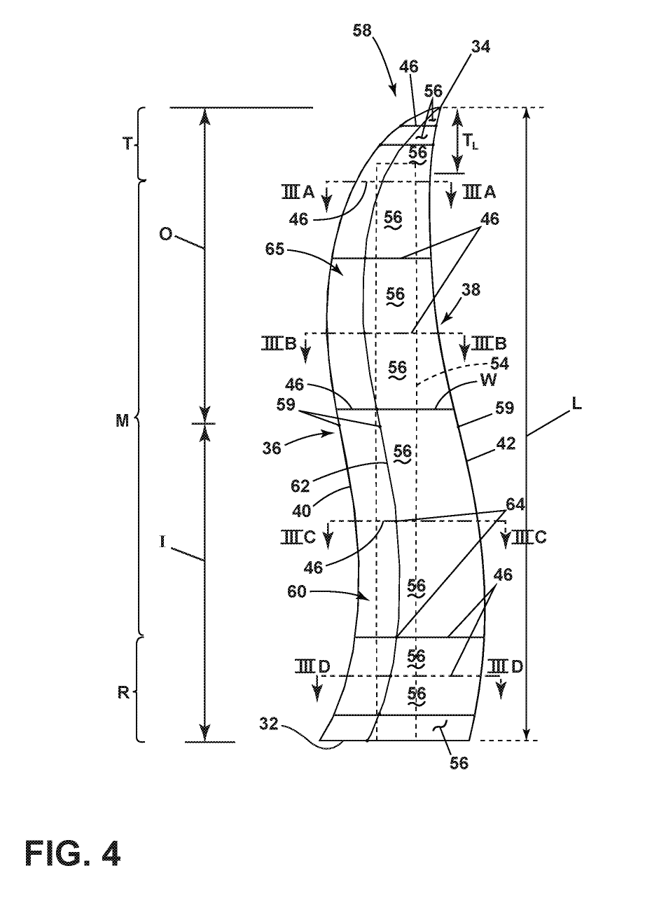

First and second splines 40, 42, are defined as continuous curves constructed so as to pass through a given set of points. The first and second splines 40, 42, respectively, geometrically define the leading edge 36 and trailing edge 38. An S-shape (S) is defined for the body 30 of the propeller blade 18 when viewed in planform (FIG. 4).

The first and second splines 40, 42 transition from a convex orientation in a radially inner region I located between the root 32 and fifty percent of the total radial length L of the propeller blade 18 to a concave orientation in a radially outer region O located between the radially inner region I and the blade tip 34. While the radially inner region I is described as located between the blade root 32 and approximately fifty percent of the total radial length L of the propeller blade 18, alternative configurations of the propeller blade 18 can include that the inner region I is defined to include more or less of the total radial length L of the propeller blade 18.

FIGS. 4A-4D are cross-sections of portions of the airfoil 39 of the propeller blade 18. The airfoil 39 extends axially from the leading edge 36 to the trailing edge 38. A chord line 46 spans from the leading edge 36 to the trailing edge 38. A camber line 48 also runs from the leading edge 36 to the trailing edge 38 connecting points midway between a pressure side 50 and a suction side 52 of the airfoil 39. It should be understood that the propeller blade 18 includes numerous geometries for the airfoil 39 and FIGS. 4A-4D are provided for illustrative purposes only. It should be further understood that airfoil 39 cross-sections can be symmetrical or non-symmetrical airfoils.

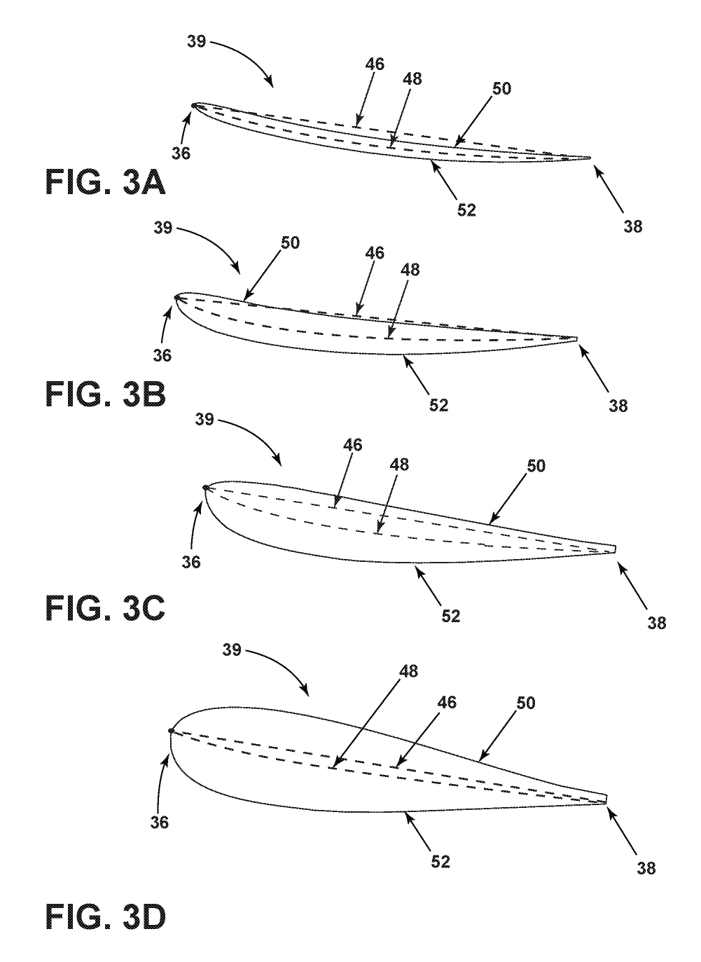

The propeller blade 18 can further include a set of airfoil sections 56 spanning axially between the leading edge 36 and trailing edge 38 and spanning radially from the root 32 to the tip 34. Each airfoil section 56 represents at least one airfoil 39 as depicted in FIGS. 3A-3D or a plurality of airfoils 39 when stacked have smooth transitioning geometry as defined by changes to the length of each chord line 46, the bend of the camber line 48 with varying thickness, and the chord line orientation. Together the airfoil sections 56 form the S-shape (S) of the propeller blade 18 in planform.

FIG. 4 illustrates a planform view of the propeller blade 18 with the total length L, which is the length of the propeller blade 18 normal to the radial direction of the propeller blade 18, and a varying width W defined by the length of the chord lines 46 at each radial station. As the propeller blade 18 extends radially from the root 32 to the tip 34 the width W varies from the root 32 to the tip 34 in accordance with the propeller blade chord distribution.

The propeller blade 18 can include a straight spar 54 spanning from the root 32 toward the tip 34. The spar 54 is the main internal structural element of the propeller blade 18 for carrying aerodynamic and centrifugal loads. The spar 54 can be formed from a variety of materials, for example but not limited to carbon-reinforced composite material. The straight spar 54 is not meant to be limiting and can be for example a swept spar having a variety of angles and formed to mirror the sweep of the propeller blade 18.

A sweep line 62 connects multiple points 64 located at 44% of the length of the chord line 46 closest to the leading edge 36. While illustrated as 44%, the sweep line 62 can connect points between 15% and 60% of the chord length. The sweep line 62 defines a backward swept section 60 containing points backwardly offset from neighboring points of the sweep line 62 in an inner region I radially outward of the root 32.

Inflection points 59 in a middle section M are located at a point along each of the first and second splines 40, 42 and the sweep line 62. The inflection points 59 include where there is a change from one of a concave or convex orientation to one of a convex or concave orientation occurs. The inflection points 59 are not limited to the locations illustrated, and can be at any radial position and be different for each of the first and second splines 40, 42, and the sweep line 62.

An outer region O comprises a forward swept section 65 terminating in a tip region T having a tip length T_{L} that is 10% of the total length L. A highly swept portion 58 of the sweep line 62 in tip region T can have a variable sweep angle.

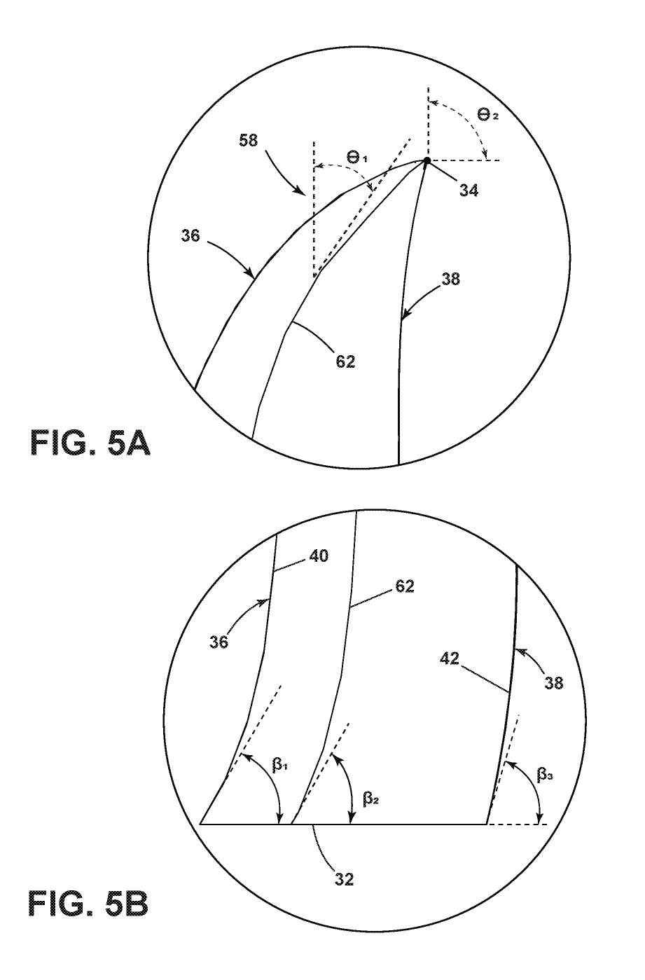

Turning to FIG. 5A an enlarged view of the tip region T illustrates the variable sweep angle as θ₁ and θ₂ ranging from 40 to 90°. While illustrated as two angles θ₁ and θ₂, it is understood that a plurality of angles can define the variable sweep angle θ along sweep line 62 in the tip region T.

In FIG. 5B an enlarged view of a root region R, the first and second splines 40, 42 along with the sweep line 62 each terminate at the root 32 in a rearwardly angled orientation with backward angles β₁, β₂, β₃ of between 0 and 90°.

The first spline 40 along the leading edge 36 and the sweep line 62 can have the smaller backward angles β₁, β₂ ranging from 30°-85° while the second spline 42 along the trailing edge 38 can have the larger backward angle β₃ ranging from 60°-120° when compared to each other. The first spline 40 and sweep line 62 can therefore parallel each other in the root region R continuing on into the middle section M, until the highly swept portion 58 where all three splines 40, 42, 62 terminate at the tip 34, where the tip 34 is defined by a point or an airfoil having a chord.

It should be understood that elements related to the disclosure described herein are for illustrative purposes only and not meant to be limiting. It can be further contemplated that a propeller blade having at least one inflection point can have multiple inflection points and that the shape can differ from that of an S-Shape as described herein.

Benefits associated with the S-Shaped propeller blade described herein include the highly swept portion which reduces propeller noise and the backward swept inner region which increases efficiency. Additionally incorporating a backward angle at the root of the propeller blade allows for a better spinner to propeller blade airflow. The waved trailing edge reduces propeller-wing interference while still maintaining a straight spar internal structure. Inclusion of the internal straight spar would not require any manufacturing changes, which would be most cost effective but not necessary.

To the extent not already described, the different features and structures of the various embodiments can be used in combination with each other as desired. That one feature cannot be illustrated in all of the embodiments is not meant to be construed that it cannot be, but is done for brevity of description. Thus, the various features of the different embodiments can be mixed and matched as desired to form new embodiments, whether or not the new embodiments are expressly described. Moreover, while “a set of” various elements have been described, it will be understood that “a set” can include any number of the respective elements, including only one element. Combinations or permutations of features described herein are covered by this disclosure. Further, it will be understood that many other possible embodiments and configurations in addition to those shown in the above figures are contemplated by the present disclosure.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

### ASPECTS

Various characteristics, aspects, and advantages of the present disclosure may also be embodied in the following technical solutions as defined by the clauses:

1. A propeller blade, comprising:
a leading edge;
a trailing edge spaced from the leading edge; and
a set of airfoil sections between the leading edge and the trailing edge and extending radially between a blade root and a blade tip;
wherein a sweep line of the propeller blade comprises at least one inflection point.

2. The propeller blade of aspect 1, further comprising a straight spar internal structure.

3. The propeller blade of either of aspect 1 or 2, wherein a sweep angle of the blade tip is greater than 50 degrees.

4. The propeller blade of aspect 3, wherein the blade tip comprises a variable sweep angle that ranges from 50 degrees to 90 degrees.

5. The propeller blade of either of aspect 3 or 4, wherein the blade tip has a length that is 10 percent of a total length of the propeller blade.

6. The propeller blade of any preceding aspect, wherein a spline along the leading edge comprises a backward swept section.

7. The propeller blade of aspect 6, wherein the backward swept section is located in an inner region between the blade root and a blade outer region.

8. The propeller blade of any preceding aspect, wherein the leading edge at the blade spinner coupling is rearwardly angled.

9. The propeller blade of aspect 8, wherein the leading edge is rearwardly angled between 30 degrees and 85 degrees.

10. The propeller blade of any preceding aspect, wherein the set of airfoil sections define an S-shaped planform.

11. The propeller blade of any preceding aspect, wherein the trailing edge is a waved trailing edge.

12. A propeller assembly, comprising:
a rotatable hub;
a set of propeller blades with a blade, comprising:
a leading edge;
a trailing edge spaced from the leading edge and forming an airfoil there between;
a radially inner region located between a blade root and fifty percent of a total length of the propeller blade; and
a radially outer region located between the radially inner region and a blade tip of the propeller blade;
wherein a sweep line of the blade at the inner region is one of concave or convex and a sweep line of the blade at the outer region is the other of concave or convex.

13. The propeller assembly of aspect 12, wherein the leading edge of the blade at the rotatable hub is rearwardly angled.

14. The propeller assembly of either of aspect 12 or 13, wherein the blade tip comprises a sweep angle greater than 50 degrees.

15. The propeller assembly of aspect 14, wherein the blade tip comprises a variable sweep angle that ranges from 50 degrees to 90 degrees.

16. The propeller assembly of any of aspects 12 to 15, wherein the blade further comprises a straight spar internal structure.

17. A propeller, comprising:
a blade body having a leading edge and a trailing edge spaced from the leading edge and forming an airfoil there between with a S-shaped planform having at least one inflection point defined by a point where a sweep line of the blade body changes from being one of concave or convex to the other of concave or convex.

18. The propeller of aspect 17, wherein the blade body further comprises a straight spar internal structure.

19. The propeller of either of aspect 17 or 18, wherein the trailing edge is a waved trailing edge.

20. The propeller of any of aspects 17 to 19, wherein the leading edge at the blade spinner coupling is rearwardly angled.

1. A propeller blade, comprising:
a leading edge;
a trailing edge spaced from the leading edge; and
a set of airfoil sections between the leading edge and the trailing edge and extending radially between a blade root and a blade tip;
wherein a sweep line of the propeller blade comprises at least one inflection point.

2. The propeller blade of claim 1, further comprising a straight spar internal structure.

3. The propeller blade of claim 2, wherein a sweep angle of the blade tip is greater than 50 degrees.

4. The propeller blade of claim 3, wherein the blade tip comprises a variable sweep angle that ranges from 50 degrees to 90 degrees.

5. The propeller blade of claim 4, wherein the blade tip has a length that is 10 percent of a total length of the propeller blade.

6. The propeller blade of claim 1, wherein a spline along the leading edge comprises a backward swept section.

7. The propeller blade of claim 6, wherein the backward swept section is located in an inner region between the blade root and a blade outer region.

8. The propeller blade of claim 1, wherein the leading edge at the blade spinner coupling is rearwardly angled.

9. The propeller blade of claim 8, wherein the leading edge is rearwardly angled between 30 degrees and 85 degrees.

10. The propeller blade of claim 1, wherein the set of airfoil sections define an S-shaped planform.

11. The propeller blade of claim 1, wherein the trailing edge is a waved trailing edge.

12. A propeller assembly, comprising:
a rotatable hub;
a set of propeller blades with a blade, comprising:
a leading edge;
a trailing edge spaced from the leading edge and forming an airfoil there between;
a radially inner region located between a blade root and fifty percent of a total length of the propeller blade; and
a radially outer region located between the radially inner region and a blade tip of the propeller blade;
wherein a sweep line of the blade at the inner region is one of concave or convex and a sweep line of the blade at the outer region is the other of concave or convex.

13. The propeller assembly of claim 12, wherein the leading edge of the blade at the rotatable hub is rearwardly angled.

14. The propeller assembly of claim 13, wherein the blade tip comprises a sweep angle greater than 50 degrees.

15. The propeller assembly of claim 14, wherein the blade tip comprises a variable sweep angle that ranges from 50 degrees to 90 degrees.

16. The propeller assembly of claim 15, wherein the blade further comprises a straight spar internal structure.

17. A propeller, comprising:
a blade body having a leading edge and a trailing edge spaced from the leading edge and forming an airfoil there between with a S-shaped planform having at least one inflection point defined by a point where a sweep line of the blade body changes from being one of concave or convex to the other of concave or convex.

18. The propeller of claim 17, wherein the blade body further comprises a straight spar internal structure.

19. The propeller of claim 18, wherein the trailing edge is a waved trailing edge.

20. The propeller of claim 19, wherein the leading edge at the blade spinner coupling is rearwardly angled.
